(19) United States
(12) Patent Application Publication
(10) Pub. No.: US 2024/0128501 A1
(43) Pub. Date: Apr. 18, 2024

(54) SOLID ELECTROLYTE AND METHOD OF PREPARING THE SAME

(71) Applicants: SAMSUNG SDI CO., LTD., Yongin-si (KR); HYUNDAI MOTOR COMPANY, Seoul (KR); KIA CORPORATION, Seoul (KR)

(72) Inventors: Pilsang YUN, Yongin-si (KR); Hyunbeom KIM, Yongin-si (KR); Suk-Gi HONG, Yongin-si (KR); Myeongju HA, Yongin-si (KR); Hwichul YANG, Yongin-si (KR)

(21) Appl. No.: 18/379,350

(22) Filed: Oct. 12, 2023

(30) Foreign Application Priority Data
Oct. 14, 2022 (KR) 10-2022-0132693

(51) Int. Cl. H01M 10/0562

(52) U.S. Cl. CPC H01M 10/0562; H01M 2300/008; H01M 2300/0094

(57) ABSTRACT

A solid electrolyte, including a sulfide solid electrolyte particle and lithium-metal-phosphate on the surface of the sulfide solid electrolyte particles wherein in an X-ray diffraction analysis of the solid electrolyte, a full width at half maximum (FWHM) of a main peak is less than or equal to about 0.160.

### CROSS-REFERENCE TO RELATED APPLICATION

This application claims priority to and the benefit of Korean Patent Application No. 10-2022-0132693, filed in the Korean Intellectual Property Office on Oct. 14, 2022, the entire contents of which are incorporated herein by reference.

### BACKGROUND

### 1. Field

Embodiments relate to solid electrolytes and methods of preparing the same.

### 2. Description of the Related Art

Recently, as a risk of explosion of a battery using a liquid electrolyte has been reported, development of an all-solid-state battery has been actively conducted. However, a solid electrolyte, compared to the liquid electrolyte, has problems of low ion conductivity, resistance on the interface with solid particles of a positive electrode active material and the like in a battery, deterioration of the ion conduction performance by formation of a depletion layer by solid-to-solid bonding, and the like.

### SUMMARY

Embodiments are directed to a solid electrolyte, including sulfide solid electrolyte particles and lithium-metal-phosphate on a surface of the sulfide solid electrolyte particles, wherein in an X-ray diffraction analysis of the solid electrolyte, a full width at half maximum (FWHM) of a main peak is less than or equal to about 0.160.

In embodiments the lithium-metal-phosphate includes a metal, and the metal may be Al, B, Ca, Ce, Cr, Fe, Mg, Mo, Nb, Si, Sn, Sr, Ta, V, W, or Zr.

In embodiments the lithium-metal-phosphate may be included in an amount of about 0.01 wt % to about 3 wt % based on a total weight of the solid electrolyte.

In embodiments the lithium-metal-phosphate may be included in an amount of about 0.01 wt % to about 0.8 wt % based on a total weight of the solid electrolyte.

In embodiments the lithium-metal-phosphate may be amorphous.

In embodiments the sulfide solid electrolyte particles may include an argyrodite-type sulfide.

In embodiments an average particle diameter (D50) of the solid electrolyte may be about 0.1 μm to about 5.0 μm.

In embodiments a value of (D90 D10)/D50 in a particle size distribution for the solid electrolyte may be greater than about 1 and less than or equal to about 5.

Embodiments are directed to a method of preparing a solid electrolyte, including mixing sulfide solid electrolyte particles and lithium-metal-phosphate and performing a heat treatment at about 250° C. to about 350° C.

In embodiments the heat treatment may be performed for about 0.5 to about 10 hours in an inert gas or nitrogen atmosphere.

In embodiments the lithium-metal-phosphate may be mixed in an amount of about 0.01 to about 3 parts by weight based on 100 parts by weight of the sulfide solid electrolyte particles.

In embodiments the lithium-metal-phosphate may be mixed in an amount of about 0.01 to about 0.8 parts by weight based on 100 parts by weight of the sulfide solid electrolyte particles.

In embodiments the sulfide solid electrolyte particles may include an argyrodite-type sulfide.

In embodiments an average particle diameter (D50) of the sulfide solid electrolyte may be about 0.1 μm to about 5.0 μm.

In embodiments the lithium-metal-phosphate may include a metal, and the metal may be Al, B, Ca, Ce, Cr, Fe, Mg, Mo, Nb, Si, Sn, Sr, Ta, V, W, or Zr.

In embodiments the lithium-metal-phosphate may be amorphous.

In embodiments the lithium-metal-phosphate may be in the form of particles and an average particle diameter (D50) thereof may be about 0.01 μm to about 1.0 μm.

In embodiments a full width at half maximum (FWHM) of a main peak in an X-ray diffraction analysis of the prepared solid electrolyte may be less than or equal to about 0.160.

In embodiments the method may include mixing sulfur-containing raw materials and performing a heat treatment to prepare a sulfide solid electrolyte, pulverizing the prepared sulfide solid electrolyte to obtain sulfide solid electrolyte particles having an average particle diameter (D50) of about 0.1 μm to about 5.0 μm, and mixing the obtained sulfide solid electrolyte particles with lithium-metal-phosphate and performing a heat treatment at about 250° C. to about 350° C.

In embodiments the mixing of sulfur-containing raw materials and performing heat treatment to prepare the sulfide solid electrolyte may include a first heat treatment of mixing sulfur-containing raw materials and firing at about 120° C. to about 350° C. and a second heat treatment of mixing the resultant of the first heat treatment and firing the same at about 350° C. to about 800° C.

### BRIEF DESCRIPTION OF THE DRAWINGS

Features will become apparent to those of skill in the art by describing in detail exemplary embodiments with reference to the attached drawings in which:

FIG. 1 is a graph showing a particle size distribution curve for solid electrolytes of Example 2 and Comparative Examples 1 and 2;

FIG. 2 is an X-ray diffraction analysis graph of the solid electrolyte and the coating agent (LZP) of Examples 1 to 4 and Comparative Examples 1 and 2;

FIG. 3 is a graph showing full widths at half maximum (bar graph, left vertical axis) of the main peak and ion conductivity (dotted line graph, right vertical axis) in the X-ray diffraction analyses of the solid electrolytes of Examples 1 to 4 and Comparative Examples 1 and 2; and

FIG. 4 is a moisture stability evaluation graph for the solid electrolytes of Examples 1 and 4 and Comparative Example 2, the bar graphs corresponding to the left vertical axis shows ionic conductivity before and after being left for 3 days, and the dotted line graph corresponding to the right vertical axis shows ionic conductivity retention rate before and after being left for 3 days.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

The terminology used herein is used to describe embodiments only, and is not intended to limit the present invention. The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

It will be understood that if/when an element such as a layer, film, region, or substrate is referred to as being “on” another element, it can be directly on the other element or intervening elements may also be present. In contrast, if/when an element is referred to as being “directly on” another element, there are no intervening elements present.

In addition, “layer” herein includes not only a shape formed on the whole surface if/when viewed from a plan view, but also a shape formed on a partial surface.

In addition, the average particle diameter may be measured by a method well known to those skilled in the art, for example, may be measured by a particle size analyzer, or may be measured by a transmission electron microscopic photograph or a scanning electron microscopic photograph. Alternatively, it is possible to obtain an average particle diameter value by measuring it using a dynamic light scattering method, performing data analysis, counting the number of particles for each particle size range, and calculating from this. The average particle diameter may be measured by a microscope image or a particle size analyzer, and may mean a diameter (D50) of particles having a cumulative volume of about 50 volume % in a particle size distribution.

Herein, “or” is not to be construed as an exclusive meaning, for example, “A or B” is construed to include A, B, A+B, and the like.

Preparing Method of Solid Electrolyte

Some example embodiments provide a method for preparing a solid electrolyte which includes mixing sulfide solid electrolyte particles and lithium-metal-phosphate and performing a heat treatment at about 250° C. to about 350° C.

In general, a solid electrolyte should have an appropriate particle size distribution to exhibit excellent ion conduction performance in a battery and implement high energy density, and implement excellent particle fluidity, that is, a high-density electrode plate and electrolyte film. At the same time, the solid electrolyte should be able to exhibit improved ion conductivity by maintaining high crystallinity.

A sulfide solid electrolyte is a material capable of realizing high ion conductivity among various solid electrolytes. Immediately after synthesis at a high temperature, since the particles are severely aggregated or have a large particle size, it may be necessary to pulverize them. However, the ion conductivity may decrease due to the pulverizing operation, and if heat treatment is performed to increase the ion conductivity, the particles may be re-aggregated and grow.

In order to solve the problems, some example embodiments adopt a method of heat-treating the pulverized sulfide solid electrolyte particles within a temperature range of about 250° C. to about 350° C., while coating the pulverized sulfide solid electrolyte particles with lithium-metal-phosphate. This method improves the ion conductivity as well as increases crystallinity of the solid electrolyte and simultaneously, suppresses the particles from the aggregation and growth and successfully realizes a high-density electrode plate and electrolyte film with an appropriate particle size distribution. This solid electrolyte may also secure high moisture stability to improve capacity characteristics, initial charge and discharge efficiency, and cycle-life characteristics of a battery.

In the heat treatment, e.g., if the heat treatment is performed at a temperature of less than about 250° C., crystallinity may not be sufficiently increased, and thus high ion conductivity may not be realized. In addition, if heat treatment is performed at a temperature greater than about 350° C., aggregation and growth of particles may occur, so that an appropriate particle size distribution may not be obtained, and thus crystallinity may be lowered. The higher the heat treatment at a higher temperature, the more coating agents may be required, which may cause a problem in that the ion conductivity may be rather deteriorated.

The heat treatment may be performed in a nitrogen atmosphere or an inert gas such as He or Ar. In addition, the heat treatment may be performed for about 0.5 to about 10 hours, e.g., for about 1 to about 8 hours. In the case of heat treatment under these conditions, the prepared solid electrolyte may realize an appropriate particle size distribution while exhibiting excellent ion conductivity.

The lithium-metal-phosphate may be mixed in an amount of about 0.01 to about 3 parts by weight based on 100 parts by weight of the sulfide solid electrolyte particles, e.g., about 0.01 to about 2 parts by weight, about 0.1 to about 1 part by weight, about 0.25 to about 0.8 parts by weight or about 0.3 to about 0.75 parts by weight. If mixed in this content range, the prepared solid electrolyte may have an appropriate particle size distribution without particle size aggregation while exhibiting high ion conductivity. Particularly, if about 0.3 to about 0.8 parts by weight of the lithium-metal-phosphate is mixed with 100 parts by weight of the sulfide solid electrolyte particles, an appropriate amount of the lithium-metal-phosphate may be evenly coated on the surface of the sulfide solid electrolyte, which may further improve the ion conductivity of the solid electrolyte.

A preparing method of the solid electrolyte according to some example embodiments includes, e.g., mixing sulfur-containing raw materials and performing heat treatment to synthesize a sulfide solid electrolyte, pulverizing the synthesized sulfide solid electrolyte, and mixing the pulverized sulfide solid electrolyte particles with lithium-metal-phosphate and performing heat treatment at about 250° C. to about 350° C. to obtain the solid electrolyte in which lithium-metal-phosphate is disposed on the surface of the sulfide solid electrolyte particles.

In some example embodiments, the mixing of the sulfide solid electrolyte particles and lithium-metal-phosphate and performing heat treatment may be referred to as a type of dry coating method. That is, the preparing method of the solid electrolyte according to some example embodiments may be a method of coating sulfide solid electrolyte particles, and may be, e.g., a method of dry-coating lithium-metal-phosphate on the surface of sulfide solid electrolyte particles. Unlike other oxide-based inorganic solid electrolytes or positive electrode active materials, sulfide solid electrolytes have characteristics that wet coating is difficult and vulnerable to high-temperature heat treatment, and thus the sulfide solid electrolytes require a design for difficult coating conditions. In addition, in general, since the wet coating method uses an alcohol based solvent or alkoxide-based raw materials, a carbon component may locally remain after the coating and adversely affect the ion conductivity and the like. The method of manufacturing the solid electrolyte according to some example embodiments has different conditions from coating different types of solid electrolyte particles and in addition, is distinguished from general wet coating.

Sulfide Solid Electrolyte Particles

The sulfide solid electrolyte particles may include, e.g., Li₂S—P₂S₅, Li₂S—P₂S₅—LiX (wherein X may be a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ(wherein m and n may each be an integer and Z may be Ge, Zn or Ga), Li₂S—GeS₂, Li₂S—SiS₂—Li₃PO₄, Li₂S—SiS₂-LiₚMO_{q} (wherein p and q may each be an integer and M may be P, Si, Ge, B, Al, Ga, or In), or a combination thereof.

Such a sulfide solid electrolyte may be obtained by, e.g., mixing Li₂S and P₂S₅ in a mole ratio of about 50:50 to about 90:10 or about 50:50 to about 80:20 and optionally performing a heat treatment. Within the above mixing ratio range, a sulfide solid electrolyte having excellent ion conductivity may be prepared. The ion conductivity may be further improved by adding SiS₂, GeS₂, B₂S₃, and the like as other components thereto.

Mechanical milling or a solution method may be applied as a mixing method of sulfur-containing raw materials for preparing a sulfide solid electrolyte. The mechanical milling may be to make starting materials into particulates by putting the starting materials, ball mills, and the like in a reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ion conductivity may be improved. In an implementation, the sulfide solid electrolyte may be prepared by mixing sulfur-containing raw materials and performing a heat treatment two or more times. In this case, a sulfide solid electrolyte having high ion conductivity and robustness may be prepared.

The sulfide solid electrolyte particles according to some example embodiments, e.g., may be prepared through a first heat treatment of mixing sulfur-containing raw materials and firing at about 120° C. to about 350° C. and a second heat treatment of mixing the resultant of the first heat treatment and firing the same at about 350° C. to about 800° C. The first heat treatment and the second heat treatment may be performed in an inert gas or nitrogen atmosphere, respectively. The first heat treatment may be performed for about 1 hour to about 10 hours, and the second heat treatment may be performed for about 5 hours to about 20 hours. Small raw materials may be milled through the first heat treatment, and a final solid electrolyte may be synthesized through the second heat treatment. Through such two or more heat treatments, a sulfide solid electrolyte having high ion conductivity and high performance may be obtained, and such a solid electrolyte may be suitable for mass production. The temperature of the first heat treatment may be, e.g., about 150° C. to about 330° C., or about 200° C. to about 300° C., and the temperature of the second heat treatment may be, e.g., about 380° C. to about 700° C., or about 400° C. to about 600° C.

In an implementation, the sulfide solid electrolyte particles may include argyrodite-type sulfide. The argyrodite-type sulfide may be, e.g., represented by the chemical formula, LiₐM_{b}PS_{d}Aₑ (wherein a, b, c, d, and e may each be 0 or more and 12 or less, M may be Ge, Sn, Si, or a combination thereof, and A may be F, Cl, Br, or I), and as a specific example, it may be represented by the chemical formula of Li₇₋ₓPS₆₋ₓAₓ (wherein x may be 0.2 or more and 1.8 or less, and A may be F, Cl, Br, or I). In implementations, the argyrodite-type sulfide may be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, and the like.

The sulfide solid electrolyte particles including such argyrodite-type sulfide may have high ion conductivity close to the range of about 10⁻⁴ to about 10⁻² S/cm, which is the ion conductivity of general liquid electrolytes at room temperature, and may form an intimate bond between the positive electrode active material and the solid electrolyte without causing a decrease in ion conductivity, and furthermore, an intimate interface between the electrode layer and the solid electrolyte layer. An all-solid-state battery including the same may have improved battery performance such as rate capability, coulombic efficiency, and cycle-life characteristics.

The argyrodite-type sulfide solid electrolyte may be prepared, e.g., by mixing lithium sulfide and phosphorus sulfide, and optionally lithium halide. A heat treatment may be performed after mixing them. The heat treatment may include, e.g., two or more heat treatment steps.

A method of preparing a solid electrolyte according to some example embodiments may include mixing lithium sulfide, phosphorus sulfide, and optionally lithium halide to prepare argyrodite-type sulfide solid electrolyte particles, and mixing the prepared argyrodite-type sulfide solid electrolyte particles with lithium-metal-phosphate and performing a heat treatment at about 250° C. to about 350° C.

In an implementation, the method for preparing the solid electrolyte may include mixing lithium sulfide, phosphorus sulfide, and optionally lithium halide and performing a heat treatment to prepare argyrodite-type sulfide solid electrolyte particles, pulverizing the prepared argyrodite-type sulfide solid electrolyte particles, and mixing the pulverized argyrodite-type sulfide solid electrolyte particles and lithium-metal-phosphate and performing a heat treatment at about 250° C. to about 350° C.

Herein, in the step of preparing the argyrodite-type sulfide solid electrolyte, the heat treatment may include, e.g., a first heat treatment in which raw materials are mixed and fired at about 120° C. to about 350° C., and a second heat treatment in which the resultant of the first heat treatment is mixed again and fired at about 350° C. to about 800° C.

An average particle diameter (D50) of the sulfide solid electrolyte particles according to some example embodiments may be less than or equal to about 5.0 μm, for example, about 0.1 μm to about 5.0 μm, about 0.1 μm to about 4.0 μm, about 0.1 μm to about 3.0 μm, about 0.5 μm to about 2.0 μm, or about 0.1 μm to about 1.5 μm. The sulfide solid electrolyte particles having this particle size range may effectively penetrate between positive electrode active materials, and may have excellent contact with the positive electrode active material and connectivity between solid electrolyte particles. The average particle diameter of the sulfide solid electrolyte particles may be measured using a microscope image, and, e.g., a particle size distribution may be obtained by measuring the size of about 20 particles in a scanning electron microscope image, and D50 may be calculated therefrom.

Lithium-Metal-Phosphate

Lithium-metal-phosphate according to some example embodiments may mean a phosphate including lithium and a metal other than lithium. Herein, the metal is a concept that includes general metals, transition metals, and semi-metals. In the lithium-metal-phosphate, the metal may be one or more elements selected from Al, B, Ca, Ce, Cr, Fe, Mg, Mo, Nb, Si, Sn, Sr, Ta, V, W, or Zr.

The lithium-metal-phosphate may be amorphous. According to some example embodiments, if amorphous lithium-metal-phosphate is coated on the sulfide solid electrolyte particles, the prepared solid electrolyte may realize higher ion conductivity and interfacial resistance with other solid particles such as a positive electrode active material in a battery, prevent aggregation of solid electrolyte particles, improve ion conductivity, and improve capacity characteristics, cycle-life characteristics, and the like.

The lithium-metal-phosphate mixed in the method for preparing a solid electrolyte may be in the form of particles, and its average particle diameter (D50) may be, e.g., about 0.01 μm to about 1.0 μm, about 0.01 μm to about 0.9 μm, about 0.01 μm to about 0.8 μm, or about 0.01 μm and about 0.5 μm. The average particle diameter of the lithium-metal-phosphate may be smaller than that of the sulfide solid electrolyte particles. If using lithium-metal-phosphate having such a particle size range, it may be evenly coated on the surface of the sulfide solid electrolyte particles, sufficiently increase ion conductivity of the solid electrolyte and improve moisture stability.

Solid Electrolyte

In some example embodiments, a solid electrolyte may include sulfide solid electrolyte particles and lithium-metal-phosphate on the surface of the sulfide solid electrolyte particles, wherein in an X-ray diffraction analysis of the solid electrolyte, a full width at half maximum (FWHM) of a main peak is less than or equal to about 0.160.

The lithium-metal-phosphate may be present in the form of a film or an island on the surface of the sulfide solid electrolyte particle. In an implementation, it can be described that the solid electrolyte according to some example embodiments may include sulfide solid electrolyte particles and a coating layer on the surface of the particles, and the coating layer includes lithium-metal-phosphate.

The solid electrolyte according to some example embodiments may have a form in which lithium-metal-phosphate may be coated on the surface of sulfide solid electrolyte particles, and crystallinity of the solid electrolyte is sufficiently high to realize excellent ion conductivity and at the same time to have an appropriate particle size distribution without particle aggregation. As the crystallinity of the solid electrolyte increases or the size of the crystal increases, a full width at half maximum (FWHM) of a main peak decreases in X-ray diffraction analysis. The solid electrolyte according to some example embodiments may have a full width at half maximum of the main peak of less than or equal to about 0.160. Herein, the main peak refers to a peak having the highest diffraction intensity in X-ray diffraction analysis. The full width at half maximum of the main peak in the X-ray diffraction analysis of the solid electrolyte according to some example embodiments may be, e.g., less than or equal to about 0.159, or less than or equal to about 0.155. As such, it is known that the ion conductivity may be improved if the full width at half maximum is reduced, that is, if the crystallinity is increased. In an implementation, if the crystal size is increased, the grain boundary may be reduced and the ion conductivity may be improved.

As described above, since the sulfide solid electrolyte may exhibit particle aggregation or a large particle size right after the synthesis, if a pulverization process and the like are performed to adjust it into a usable particle size for a battery, the crystallinity may be decreased, and the ion conductivity may be deteriorated. The solid electrolyte according to some example embodiments may be prepared by heat-treating the sulfide solid electrolyte particles within a specific temperature range, while coating the sulfide solid electrolyte particles with lithium-metal-phosphate to increase the crystallinity and thus adjust a full width at half maximum (FWHM) of a main peak into about 0.160 or less and simultaneously, to secure a uniform particle size distribution without the particle aggregation and thus improve the ion conductivity.

Detailed descriptions of the sulfide solid electrolyte particles and the lithium-metal-phosphate are omitted since they have been described above.

In the solid electrolyte according to some example embodiments, the lithium-metal-phosphate may be included in an amount of about 0.01 wt % to about 3 wt %, e.g., about 0.01 wt % to about 2 wt %, about 0.01 wt % to about 1 wt %, about 0.01 wt % to about 0.8 wt %, or about 0.1 wt % to about 1.0 wt % based on 100 wt % of the solid electrolyte. If the content of lithium-metal-phosphate is as described above, the solid electrolyte may exhibit an appropriate particle size distribution without particle aggregation while realizing high ion conductivity. In particular, if the content of lithium-metal-phosphate satisfies the range of 0.01 wt % to 0.8 wt % based on 100 wt % of the solid electrolyte, the surface of the sulfide solid electrolyte particles may be evenly coated with lithium-metal-phosphate. Accordingly, the ion conductivity and moisture stability of the solid electrolyte may be further improved, and the efficiency and cycle-life characteristics of the battery may be further improved.

In the solid electrolyte, the lithium-metal-phosphate disposed on or coated on the surface of the sulfide solid electrolyte particles may be in an amorphous form. If the amorphous lithium-metal-phosphate is coated, the solid electrolyte exhibits superior ion conductivity and lowers interfacial resistance, thereby improving battery performance.

An average particle diameter (D50) of the solid electrolyte may be about 0.1 μm to about 5.0 μm, e.g., about 0.1 μm to about 4.0 μm, about 0.1 μm to about 3.0 μm, about 0.5 μm to about 2.0 μm, or about 0.1 μm to about 1.5 μm. Such a solid electrolyte may effectively penetrate between positive electrode active materials, and may have excellent contact with the positive electrode active material and connectivity between solid electrolyte particles. The average particle diameter of the solid electrolyte may be measured using a microscope image, and, e.g., a particle size distribution may be obtained by measuring the size of about 20 particles in a scanning electron microscope image, and D50 may be calculated therefrom.

The solid electrolyte according to some example embodiments may be characterized by having a uniform particle size distribution without particle aggregation. In an implementation, a value of (D90−D10)/D50 in the particle size distribution for the solid electrolyte may be greater than about 1 and less than or equal to about 5, e.g., about 1.1 to about 4.0, about 1.1 to about 3.0, or about 1.2 to about 2.0. The (D90−D10)/D50 value may indicate a degree of broadness of the peak in the particle size distribution graph for the solid electrolyte, specifically, the horizontal axis represents the particle size (μm) and the vertical axis represents the cumulative volume % of the particles. The smaller the corresponding number, the narrower the peak width of the graph, which may be interpreted as having a uniform particle size. Herein, D10 means a diameter of particles whose cumulative volume is 10 volume % in the particle size distribution, D50 means a diameter of particles whose cumulative volume is 50 volume % in the particle size distribution, and D90 means a diameter of particles whose cumulative volume is 90 volume % in the particle size distribution.

The D10 of the solid electrolyte may be, e.g., about 0.05 μm to about 0.7 μm, about 0.05 μm to about 0.6 μm, about 0.1 μm to about 0.5 μm, or about 0.2 μm to about 0.4 μm. In addition, the D90 of the solid electrolyte may be, e.g., about 0.9 μm to about 5.0 μm, about 1.0 μm to about 4.0 μm, about 1.0 μm to about 3.0 μm, or about 1.2 μm to about 2.0 μm. If the solid electrolyte has such a particle size distribution, battery performance may be improved by realizing high energy density while implementing excellent ion conductivity.

The solid electrolyte may have an ion conductivity of greater than or equal to about 2.9 mS/cm or greater than or equal to about 3.0 mS/cm at 25° C., e.g., about 2.9 mS/cm to about 5.0 mS/cm, about 3.0 mS/cm to about 4.5 mS/cm, or about 3.0 mS/cm to about 4.0 mS. The ion conductivity may be measured through electrochemical impedance spectroscopy (EIS).

Hereinafter, examples of the present invention and comparative examples are described. It is to be understood, however, that the examples are for the purpose of illustration and are not to be construed as limiting the present invention.

### Example 1

1. Preparation of Sulfide Solid Electrolyte Particles

An argyrodite-type sulfide solid electrolyte was synthesized through a method described later. All processes of mixing raw materials and pre- and post-heat treatments were performed in a glove box under an argon atmosphere. Specifically, the raw materials of lithium sulfide (Li₂S), phosphorus pentasulfide (P₂S₅), and lithium chloride (LiCl) were mixed in a mole ratio of 2.5:0.5:1, to prepare a mixed powder. The mixed powder was uniformly mixed with a Henschel mixer and then, primarily fired at 250° C. for 5 hours in a tube furnace through which argon gas was flowing at a constant speed of 8 SLM.

The primarily fired powder was uniformly mixed again with the Henschel mixer, sieved, and then, secondarily fired at 500° C. for 10 hours in the tube furnace through which argon gas was flowing at the constant speed of 8 SLM. The secondarily fired powder was pulverized and sieved, to obtain sulfide solid electrolyte particles of Li₆PS₅Cl. The obtained sulfide solid electrolyte particles had a size (D50) of 0.85 m.

2. Coating of Sulfide Solid Electrolyte Particles

100 parts by weight of the prepared sulfide solid electrolyte particles and 0.25 parts by weight of lithium-zirconium-phosphate (LZP; LiZr₂(PO₄)₃) having D50 of 0.15 μm and being amorphous as a result of X-ray diffraction analysis as a coating agent were mixed with the Henschel mixer. The mixed powder was subjected to a heat treatment at 250° C. for 5 hours in the tube furnace through which argon gas was flowing at the constant speed of 8 SLM. Through this, a solid electrolyte having the lithium-zirconium-phosphate coated on the surface of the sulfide solid electrolyte particles was prepared.

### Example 2

A solid electrolyte was prepared in the same manner as in Example 1 except that 0.5 parts by weight of the coating agent was added to prepare the solid electrolyte.

### Example 3

A solid electrolyte was prepared in the same manner as in Example 1 except that 0.75 parts by weight of the coating agent was added to prepare the solid electrolyte.

### Example 4

A solid electrolyte was prepared in the same manner as in Example 1 except that 1.0 part by weight of the coating agent was added to prepare the solid electrolyte.

### Comparative Example 1

A solid electrolyte was prepared in the same manner as in Example 1 except that the solid electrolyte was prepared by using no coating agent and performing a heat treatment at 250° C. for 5 hours.

### Comparative Example 2

A solid electrolyte was prepared in the same manner as in Example 1 except that the solid electrolyte was prepared by using no coating agent. That is, the sulfide solid electrolyte particles themselves prepared in step 1 in Example 1 were used as the solid electrolyte.

The solid electrolyte designs of Examples 1 to 4 and Comparative Examples 1 to 2 are shown in Table 1.

TABLE 1

| | Additional heat treatment | LZP (parts by weight) |
|---|---|---|
| Example 1 | 250 ° C. | 0.25 |
| Example 2 | | 0.5 |
| Example 3 | | 0.75 |
| Example 4 | | 1.0 |
| Comparative Example 1 | | — |
| Comparative Example 2 | Not | — |

### Evaluation Example 1: Evaluation of Particle Size Distribution

The particle size distributions of the solid electrolytes prepared in Examples 1 to 4 and Comparative Examples 1 to 2 were measured. The particle size distribution was measured by using xylene, from which moisture was removed, as a solvent and a particle size analyzer using a laser diffraction.

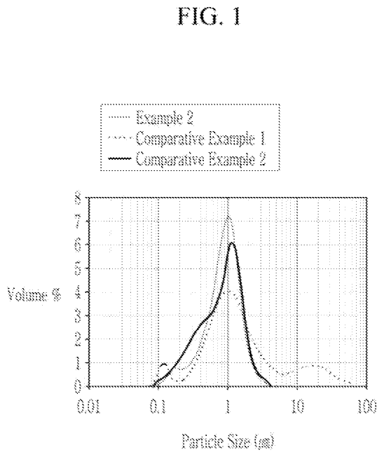

FIG. 1 shows particle size distribution curves of the solid electrolytes prepared in Example 2, Comparative Example 1, and Comparative Example 2. In FIG. 1, the horizontal axis is the particle size (μm) and the vertical axis is the volume % of the particle size.

In addition, in the particle size distribution curves of the solid electrolytes of Examples 1 to 4 and Comparative Examples 1 to 2, a particle size at a cumulative volume of 10% was provided as D1, a particle size at a cumulative volume of 50% was provided as D50, and a particle size at a cumulative volume of 90% was provided as D90 in Table 2. Furthermore, each span of the solid electrolytes was calculated according to (D90−D10)/D50 to compare how wide each of the particle size distribution curves was, and the results are shown in Table 2.

TABLE 2

| unit μm | D10 | D50 | D90 | Span |
|---|---|---|---|---|
| Example 1 | 0.230 | 0.681 | 1.448 | 1.8 |
| Example 2 | 0.329 | 0.868 | 1.550 | 1.4 |
| Example 3 | 0.261 | 0.870 | 1.457 | 1.4 |
| Example 4 | 0.349 | 0.875 | 1.636 | 1.5 |
| Comparative Example 1 | 0.369 | 1.144 | 12.890 | 10.9 |
| Comparative Example 2 | 0.260 | 0.848 | 1.644 | 1.6 |

Referring to FIG. 1, Comparative Example 1, in which a heat treatment alone was performed without coating, exhibited several peaks, which confirmed that solid electrolyte particles were aggregated. In addition, in Table 1, Comparative Example 1 exhibited that D90 and Span were significantly increased due to aggregation of the particles, compared with Comparative Example 2. In other words, if the heat treatment was additionally performed in order to increase ion conductivity of the pulverized sulfide solid electrolyte particles and the like, there was a problem of the aggregation of the particles.

On the contrary, Examples 1 to 4, referring to FIG. 1 and Table 2, had a very even particle size distribution without aggregation or growth of the particles according to the heat treatment during the coating. In addition, through this particle size distribution analysis, in the final solid electrolytes, coating agent particles with a size (D50) of about 0.15 μm were not separately present from sulfide solid electrolyte particles but evenly coated on the surface of the sulfide solid electrolyte particles.

### Evaluation Example 2: X-Ray Diffraction Analysis

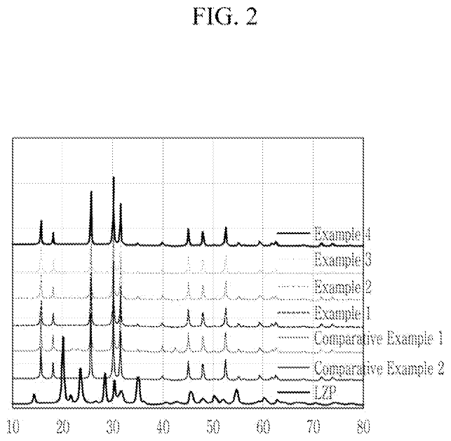

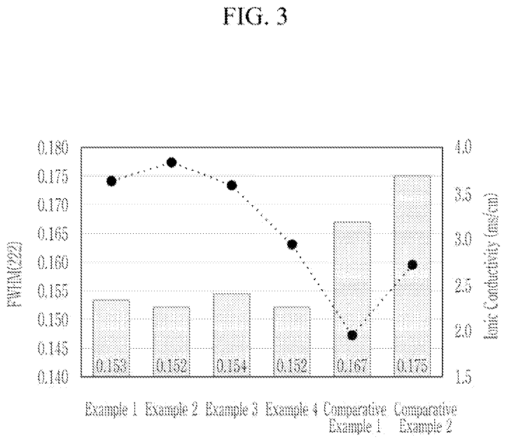

The solid electrolytes of Examples 1 to 4 and Comparative Examples 1 to 2 and a coating agent (LZP) were analyzed by X-ray diffraction, and the results are shown in FIG. 2. In addition, in the X-ray diffraction analysis of the solid electrolytes of Examples 1 to 4 and Comparative Examples 1 to 2, a full width at half maximum (FWHM) of a peak (main peak) near 30° having the highest diffraction intensity was calculated and then, shown as a bar graph in FIG. 3. Herein, the full width at half maximum (FWHM) of the main peak is a full width at half maximum (FWHM) corresponding to a Miller index (222) and may be expressed as FWHM (222).

Referring to FIG. 2, Examples exhibited no separate peak of the coating agent (LZP) itself and even Example 5 using a high content of the coating agent exhibited no LZO peak, indicating that the lithium-zirconium-phosphates on the surface of the sulfide solid electrolyte particles have very low crystallinity, that is, are present in an amorphous state.

Combining Evaluation Examples 1 and 2, lithium-metal-phosphate was evenly coated in an amorphous state on the surface of the sulfide solid electrolyte particles.

Referring to FIG. 3 showing a full width at half maximum (FWHM) of a main peak as a bar graph, Comparative Example 2 which was in a state of pulverized sulfide solid electrolyte particles, that is, before a heat treatment, exhibited a high full width at half maximum (FWHM) of 0.175, but Examples 1 to 4 exhibited a greatly reduced full width at half maximum (FWHM) of 0.155 or less, which confirmed that a crystal size increased, and crystallinity increased. Comparative Example 1 in which a heat treatment was performed at 250° C. without a coating agent, exhibited a little reduced full width at half maximum (FWHM) and thus a crystal growth, compared with Comparative Example 2, but a low increase in the crystal size, compared with the examples. Comparative Example 1, as in Evaluation Example 1, exhibited aggregation of the particles, which is understood to have a low increase in the crystal size due to a loss of heat energy.

Accordingly, if sulfide solid electrolyte particles were heat-treated within a specific temperature range, while amorphous lithium-metal-phosphate was appropriately coated on the surface of the sulfide solid electrolyte particles, the solid electrolyte particles were suppressed from the aggregation but exhibited an increase in the crystal size.

### Evaluation Example 3: Evaluation of Ion Conductivity

0.15 g of each solid electrolyte of Examples 1 to 4 and Comparative Examples 1 and 2 were charged and pressed under a pressure of 40 kgf/cm², manufacturing each torque cell. The manufactured cells were calculated with respect to ion conductivity through electrochemical impedance spectroscopy (EIS), and the results are shown as a dotted line graph in FIG. 3. EIS was performed at an amplitude of about 10 mV and a frequency of 0.1 Hz to 10⁶ Hz under an air atmosphere at 25° C. The ion conductivity was calculated by obtaining resistance from a circular arc of a Nyquist plot through EIS and considering a thickness and an area, etc. of each cell.

Referring to FIG. 3, Comparative Example 1, in which an additional heat treatment was performed, compared to Comparative Example 3 having no coating process, exhibited a low full width at half maximum (FWHM) and improved crystallinity but particle aggregation and thus significantly reduced ion conductivity. The ion conductivities of Examples were all improved compared to Comparative Examples.

Example 4, in which a content of the coating agent is increased, exhibited a little reduced ion conductivity due to aggregation of the sulfide solid electrolyte particles or resistance on the surface thereof.

### Evaluation Example 4: Evaluation of Moisture Stability

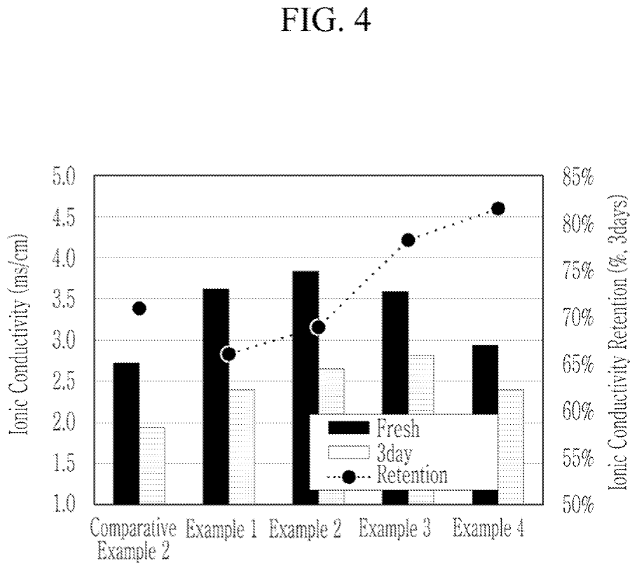

The solid electrolytes of 1 and 4 and Comparative Example 2 were left in a dry room at a dew point of −45° C. for 3 days and then, measured with respect to ion conductivity in the same manner as in Evaluation Example 3. FIG. 4 exhibits the results of Examples 1 to 4 and Comparative Example 2, wherein ion conductivity before being allowed to stand was shown as a black bar graph, ion conductivity after being allowed to stand was shown as a gray graph, and ion conductivity retention before and after allowed to stand was shown as a dotted line graph (right vertical axis).

Referring to FIG. 4, if the surface of the solid electrolyte was appropriately coated with lithium-metal-phosphate for protection, compared with Comparative Example 2 having no coating, stability to moisture was increased. Specifically, Examples 1 to 4 exhibited high ion conductivity after being allowed to stand for 3 days, that is, the gray bar of FIG. 4, from which Examples 1 to 4 exhibited improved ion conductivity, compared with Comparative Example 2.

By way of summation and review, in order to solve these problems associated with solid electrolytes, conventionally techniques of doping various elements into the positive electrode active material particles used with the solid electrolyte and forming a buffer layer including elements such as B, Nb, Zr, and the like on the surface of the positive electrode active material particles have been used. However, these methods may have difficulties in mass production, cause coat and environmental problems, and still have limitations in improving performance of the all-solid-state battery. Accordingly, it is necessary to develop a solid electrolyte having high ion conductivity and an appropriate particle size distribution.

A solid electrolyte having uniform particle size distribution, high crystallinity and high ion conductivity, and improved moisture stability and a method for preparing the same are provided herein. Additionally, the solid electrolyte according to some example embodiments has a uniform particle size distribution, high crystallinity and ion conductivity, and excellent moisture stability.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A solid electrolyte, comprising:
sulfide solid electrolyte particles and lithium-metal-phosphate on a surface of the sulfide solid electrolyte particles;
wherein in an X-ray diffraction analysis of the solid electrolyte, a full width at half maximum (FWHM) of a main peak is less than or equal to about 0.160.

2. The solid electrolyte as claimed in claim 1, wherein:
the lithium-metal-phosphate includes a metal, and
the metal is Al, B, Ca, Ce, Cr, Fe, Mg, Mo, Nb, Si, Sn, Sr, Ta, V, W, or Zr.

3. The solid electrolyte as claimed in claim 1, wherein the lithium-metal-phosphate is included in an amount of about 0.01 wt % to about 3 wt % based on a total weight of the solid electrolyte.

4. The solid electrolyte as claimed in claim 1, wherein the lithium-metal-phosphate is included in an amount of about 0.01 wt % to about 0.8 wt % based on a total weight of the solid electrolyte.

5. The solid electrolyte as claimed in claim 1, wherein the lithium-metal-phosphate is amorphous.

6. The solid electrolyte as claimed in claim 1, wherein the sulfide solid electrolyte particles include an argyrodite-type sulfide.

7. The solid electrolyte as claimed in claim 1, wherein an average particle diameter (D50) of the solid electrolyte is about 0.1 μm to about 5.0 μm.

8. The solid electrolyte as claimed in claim 1, wherein a value of (D90 D10)/D50 in a particle size distribution for the solid electrolyte is greater than about 1 and less than or equal to about 5.

9. A method of preparing a solid electrolyte, comprising:
mixing sulfide solid electrolyte particles and lithium-metal-phosphate; and
performing a heat treatment at about 250° C. to about 350° C.

10. The method of preparing a solid electrolyte as claimed in claim 9, wherein the heat treatment is performed for about 0.5 to about 10 hours in an inert gas or nitrogen atmosphere.

11. The method of preparing a solid electrolyte as claimed in claim 9, wherein the lithium-metal-phosphate is mixed in an amount of about 0.01 to about 3 parts by weight based on 100 parts by weight of the sulfide solid electrolyte particles.

12. The method of preparing a solid electrolyte as claimed in claim 9, wherein the lithium-metal-phosphate is mixed in an amount of about 0.01 to about 0.8 parts by weight based on 100 parts by weight of the sulfide solid electrolyte particles.

13. The method of preparing a solid electrolyte as claimed in claim 9, wherein the sulfide solid electrolyte particles include an argyrodite-type sulfide.

14. The method of preparing a solid electrolyte as claimed in claim 9, wherein an average particle diameter (D50) of the sulfide solid electrolyte is about 0.1 μm to about 5.0 μm.

15. The method of preparing a solid electrolyte as claimed in claim 9, wherein:
the lithium-metal-phosphate includes a metal, and
the metal is Al, B, Ca, Ce, Cr, Fe, Mg, Mo, Nb, Si, Sn, Sr, Ta, V, W, or Zr.

16. The method of preparing a solid electrolyte as claimed in claim 9, wherein the lithium-metal-phosphate is amorphous.

17. The method of preparing a solid electrolyte as claimed in claim 9, wherein the lithium-metal-phosphate is in the form of particles and an average particle diameter (D50) thereof is about 0.01 μm to about 1.0 μm.

18. The method of preparing a solid electrolyte as claimed in claim 9, wherein a full width at half maximum (FWHM) of a main peak in an X-ray diffraction analysis of the prepared solid electrolyte is less than or equal to about 0.160.

19. The method of preparing a solid electrolyte as claimed in claim 9, wherein the method includes:
mixing sulfur-containing raw materials and performing a heat treatment to prepare a sulfide solid electrolyte,
pulverizing the prepared sulfide solid electrolyte to obtain sulfide solid electrolyte particles having an average particle diameter (D50) of about 0.1 μm to about 5.0 μm, and
mixing the obtained sulfide solid electrolyte particles with lithium-metal-phosphate and performing a heat treatment at about 250° C. to about 350° C.

20. The method of preparing a solid electrolyte as claimed in claim 19, wherein the mixing of sulfur-containing raw materials and performing heat treatment to prepare the sulfide solid electrolyte includes:
a first heat treatment of mixing sulfur-containing raw materials and firing at about 120° C. to about 350° C., and
a second heat treatment of mixing the resultant of the first heat treatment and firing the same at about 350° C. to about 800° C.
